(19) United States
(12) Patent Application Publication
(10) Pub. No.: US 2009/0035979 A1
(43) Pub. Date: Feb. 5, 2009

(54) Reduced Footprint Memory Module Connector and Latching Mechanism

(75) Inventors: Brian Michael Kerrigan, Cary, NC (US); Edward John McNulty, Raleigh, NC (US); Timothy Andreas Meserth, Durham, NC (US); Tony Carl Sass, Fuquay Varina, NC (US)

Correspondence Address: IBM CORPORATION (SS/NC);c/o STREETS & STEELE, 13831 NORTHWEST FREEWAY, SUITE 355, HOUSTON, TX, 77040, US

(73) Assignee: INTERNATIONAL BUSINESS MACHINES CORPORATION, Armonk, NC (US)

(21) Appl. No.: 11/832,710

(22) Filed: Aug. 2, 2007

(51) Int. Cl. H01R 13/62

(52) U.S. Cl. 439/328

(57) ABSTRACT

One embodiment of a memory module connector includes a connector body having a slot for removably receiving a DIMM and a latching mechanism for facilitating the insertion and removal of the DIMM from the slot. The footprint of the connector may be minimized in at least four ways: (1) by orienting a lever's pivot axis so that it is parallel with a plane of the DIMM, (2) by laterally spacing the pivot axis with respect to this plane, (3) by positioning the latch at the end(s) of the connector, and (4) by uniquely sculpting the latch to minimize its contribution to the overall footprint of the connector.

### BACKGROUND OF THE INVENTION

1. Field of the Invention

The present invention relates generally to connectors for removable electronic cards, and in particular to a DIMM connector disposed on a motherboard for removably receiving a DIMM.

2. Description of the Related Art

A DIMM, or dual in-line memory module, comprises a series of random access memory chips mounted on a printed circuit board or “card” for use in computers. DIMMs are removably securable to corresponding DIMM connectors on a computer's motherboard. Each DIMM is usually retained on its associated DIMM connector by a latching mechanism included with the DIMM connector. The industry standard latching mechanism includes a latch at each end of the connector. The latches are operable by hand, allowing a person to secure or release a DIMM with the person's fingers. Usually, a DIMM is released from its connector by moving the latches outward, away from one another, in a plane generally parallel to the DIMM. This movement of the levers may also cause the DIMM to be ejected from its connector.

The advent of increasingly compact computer systems, such as blade servers, created a need for a memory module having a reduced form factor, which led to the development of Very Low Profile (VLP) DIMMs. The same design considerations that precipitated the development of VLP DIMMs make it desirable for DIMM connectors to also be compact. Current VLP DIMM connectors, however, have integral latching mechanisms similar to those of full height DIMM connectors. The outward movement of the latches requires designers to provide extra clearance or spacing on the motherboard about the DIMMs, even though this extra clearance is in opposition to achieving small component footprints. The increased clearance required around the latches is an inefficient use of the limited space on a motherboard and results in less than ideal packaging density.

### SUMMARY OF THE INVENTION

One embodiment of the invention provides a reduced-footprint memory module connector. The memory module connector includes a connector body having a slot for removably receiving a DIMM and a latching mechanism for releasably securing the DIMM. The latching mechanism includes a lever pivotally secured adjacent to an end of the connector body on a pivot axis oriented generally parallel to a longitudinal face of the DIMM. The lever is movable about the pivot axis from a first position for securing the DIMM in the slot and a second position for releasing the DIMM from the slot.

Another embodiment of the invention provides a memory module assembly including a plurality of memory module connectors. The connectors have connector bodies oriented parallel to one another on a motherboard. Each connector body has a slot for removably receiving a respective DIMM. At least one latching mechanism is included with each connector. Each latching mechanism includes a lever pivotally secured adjacent an end of the respective connector body. A pivot axis is oriented generally parallel to a longitudinal face of the respective DIMM. The lever is movable about the pivot axis from a first position for securing the respective DIMM in the slot and a second position for releasing the respective DIMM from the slot.

Other embodiments, aspects, and advantages of the invention will be apparent from the following description and the appended claims.

### BRIEF DESCRIPTION OF THE DRAWINGS

FIG. 1 is a side view of a prior art DIMM connector disposed on a motherboard and having received a DIMM.

FIG. 2 is a perspective view of a parallel arrangement of three reduced-footprint DIMM connectors according to one embodiment of the invention

FIG. 3 is a perspective view of the connector body.

FIG. 4 is an enlarged perspective view of the lever.

FIG. 5 is a face view of the VLP DIMM showing a longitudinal plane of the VLP DIMM.

FIG. 6 is a perspective view of the DIMM connectors, with one of the latches being operated to insert and secure the DIMM in a corresponding one of the connectors.

FIG. 7 is a perspective view of the DIMM connectors, with the latch being operated to release the DIMM from its fully seated, “lowered” position.

FIG. 8 is a side view of the DIMM connector and the inserted DIMM, illustrating the reduced length and footprint of the connector.

### DETAILED DESCRIPTION OF PREFERRED EMBODIMENTS

The present invention includes a reduced-footprint connector having an improved latching mechanism for facilitating the insertion and removal of a circuit board or “card” within the connector. The invention is useful, for example, in the context of memory module connectors such as “VLP DIMM” (very low profile, dual in-line memory module) connectors, and will be discussed in that context throughout. However, DIMM connectors for full-height DIMMs are also within the scope of the invention. The reduced footprint achieved by the present invention makes the invention especially valuable when applied to VLP-type DIMM connectors, for which minimizing space and size requirements is particularly desirable.

The area of a motherboard or other mounting location allocated to a connector with a latching mechanism includes not only the area or projected area of the connector as it attaches to the motherboard, but also the area or projected area on the motherboard required for the operation of the latching mechanism. In the context of the present invention, therefore, a “footprint” of a connector may be defined to include the area or projected area occupied by the connector and also any additional area or projected area that must be allocated for a user to access and operate the latching mechanism during both installation and removal of the circuit board. This characterization of a footprint considers the desire to minimize not only the two dimensional surface area of a motherboard physically occupied by a connector with latching mechanism, but also the area allocated to the connector, including the latching mechanism of the connector, and operation thereof.

In one embodiment, a connector includes a unique latching mechanism (“latch”) having features that minimize the footprint of the connector and latching mechanism. First, the latching mechanism is located at or near the end of the DIMM, so that its use does not interfere with neighboring connectors and neighboring connectors may be spaced more closely. Second, the latching mechanism includes a lever that is pivotally secured about a pivot axis that is oriented generally parallel to the DIMM to be received within the connector. Thus, operation of the latch does not require outward movement of the levers that would increase the effective length and footprint of the connector. Third, this pivot axis is laterally spaced from the plane of the circuit board to increase the linear distance of DIMM movement that the lever can achieve for a given angular displacement of the lever. Fourth, the shape of the lever is configured to allow increased angular displacement of the lever without the lever extending appreciably outside the projected width of the connector body to which the lever is attached. In one configuration, for example, the portion of the lever that would otherwise extend outside the projected boundary of the connector body is angled so as not to extend past that boundary when the latch is open, yet due to the lateral spacing of the pivot axis, the lever also does not extend appreciably beyond the opposite boundary when the latch is closed. The shape of the lever is also configured so as to avoid interference with the VLP DIMM received into the connector.

Each of these features, individually, contributes to reducing the footprint of a VLP DIMM connector according to the invention. Combined, these features optimize the connector footprint while maintaining optimal performance of the latching mechanism. An overall connector length reduction of 14%, and a circuit board space savings of 20 mm (7.5%) of the motherboard area has already been achieved according to an embodiment of the invention.

FIG. 1 is a front view of a prior art DIMM connector (“connector”) 12 disposed on a motherboard 5 of a computer, with a VLP DIMM 10 inserted. The connector 12 has conventional DIMM latches 14, which are similar to the latches on a full-height DIMM connector. The latches 14 each include a lever 15 pivotally secured to the connector 12. The pivot axis of each lever 15 is generally perpendicular to the longitudinal face 11 of the VLP DIMM 10, so that the levers 15 pivot in a plane generally parallel to the longitudinal face 11 of the VLP DIMM 10. To release the VLP DIMM 10 from the connector 12, a user pivots each lever 15 outwardly, away from one another, with the user's fingers 16A, 16B (e.g. the index finger of each hand) to release the VLP DIMM 10. This outward movement of the levers 15 may also at least partially raise the DIMM from its connector 12 as the VLP DIMM 10 is released.

While the prior art design of the connector 12 and latch 14 provides satisfactory retention and removal of the VLP DIMM 10, the outward movement of the levers 15 requires additional clearance about the VLP DIMM 10, as designated by reference dimension “A.” This requisite clearance must take into account both the width of the user's fingers 16A, 16B and the lateral, outward distance each lever 15 moves when operating the levers 15 to release the VLP DIMM 10. The effective length “L” of the connector 12 is the distance along the motherboard that is allocated for the connector 12 and operation thereof. As defined in the context of FIG. 1, the effective length L includes the anticipated width of the user's fingers 16 required to operate the levers 15. The clearance required to accommodate this outward movement also increases the projected surface area (“footprint”) of the motherboard that must be allocated to the connector 12 and its operation.

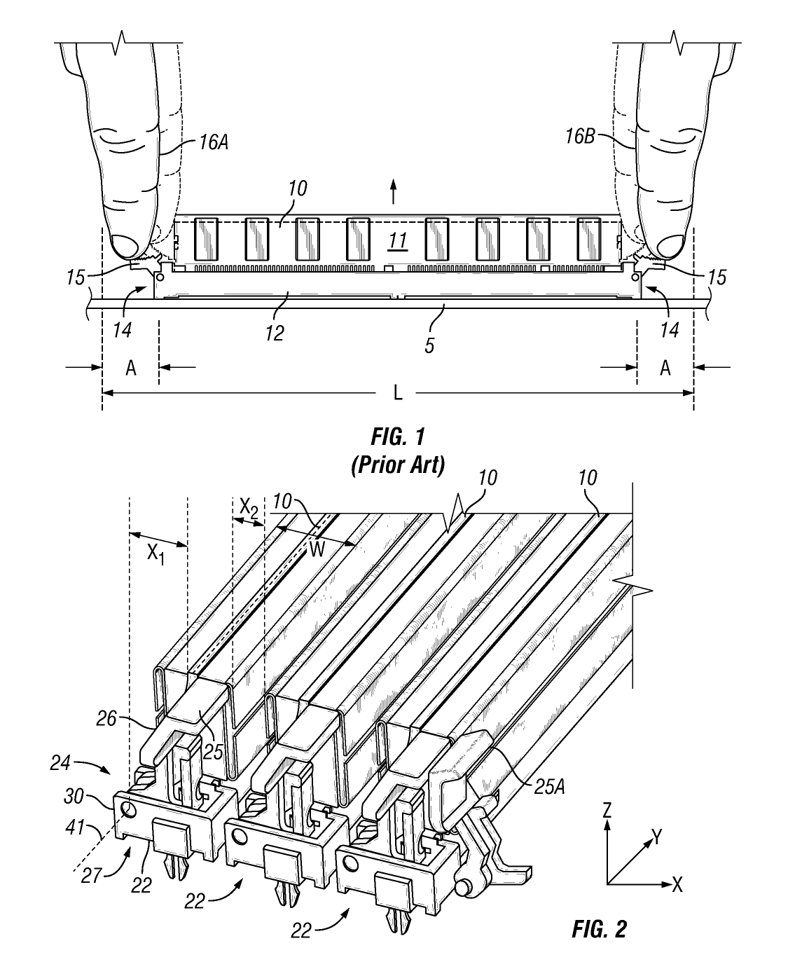

FIG. 2 is a perspective view of a parallel arrangement of three adjacent reduced-footprint DIMM connectors 22 according to one embodiment of the invention. The DIMM connectors are shown and discussed in terms of receiving the VLP DIMM 10, but the connector 12 may be configured to interchangeably accept both the VLP DIMM 10 and a so-called full-height DIMM. Although only three connectors 22 are shown, any number of connectors 22 may be arranged on a motherboard. For example, eight DIMM connectors may be arranged in a two-channel, four slots-per-channel, 533 MHz DDR2 memory system. Each connector 22 has a latching mechanism (“latch”) 24 that can be operated with minimal clearance about the connector 22. The footprint of the connector 22 is reduced in at least four novel ways: (1) by orienting a pivot axis so that it is parallel with a plane of the DIMM, (2) by laterally spacing the pivot axis with respect to this plane, (3) by positioning the latch at the end(s) of the connector, and (4) by uniquely sculpting the latch to minimize its contribution to the overall footprint of the connector. These four aspects are explained further, as follows.

First, the latch 24 includes a lever 25 pivotally secured to a lever support structure 30 about a pivot axis 41. The pivot axis 41 is generally parallel to the VLP DIMM 10, which is ninety degrees from the orientation of the conventional lever 15 with respect to its connector 12 of FIG. 1. Thus, operating the latch 24 does not require moving the lever 25 outward, so movement of the lever 25 does not appreciably increase the effective length of the connector 22. Thus, the effective length of the connector 22 according to the invention is less than the effective length of the conventional connector 12 of FIG. 1 (which pivoted outward in the “y” direction).

Second, the pivot axis 41 is laterally spaced a distance X₁ from the VLP DIMM 10. By virtue of this lateral spacing of the pivot axis 41, the latch 24 produces a greater upward (the “z” direction) displacement of the VLP DIMM 10 for a given angular rotation of the lever 25 about the pivot axis 41. This reduces the amount of angular displacement of the lever 25 required to raise and unseat the VLP DIMM 10 from the connector 22. Reducing the angular displacement of the lever 25 reduces the connector footprint by reducing the lever's required range of motion in a directional component parallel to the motherboard (the “x” direction). In this embodiment, the lever 25 does not move beyond a width W of the connector body.

Third, the latch 24 is positioned at the end of the connector 24, so that movement of the lever 25 does not impinge any of the neighboring connectors 22. This desirably minimizes a spacing “X₂” between adjacent connectors 22, which reduces the combined footprint of multiple connectors 22. This spacing X₂ can be smaller than the width of the user's finger, because, with the latch 24 at the end of the connector 24, the user's finger does not need to be inserted between the DIMMs 10 or the connectors 12 in order to operate the latches 24.

Fourth, the lever 25 is shaped to reduce the footprint of the connector 22. The lever 25 includes an angled portion 26 so that as the lever 25 is rotated counter-clockwise to release the VLP DIMM 10, the angled portion 26 is not moved beyond the width W of the connector body. As illustrated by a reference lever 25A in a counter-clockwise open position, the angled portion 26 of the levers 25 will be substantially parallel with the wall 21 when in the open position. Thus, when rotated to a position to release the VLP DIMM 10, the angled portion 26 of the lever 25 does not extend appreciably beyond the plane of wall 21 of the respective connector 22 (or alternatively, does not extend beyond a plane parallel to wall 21, but aligned with the edge 33 of the lever support structure 30). This minimizes the effective width and footprint of the connector 22.

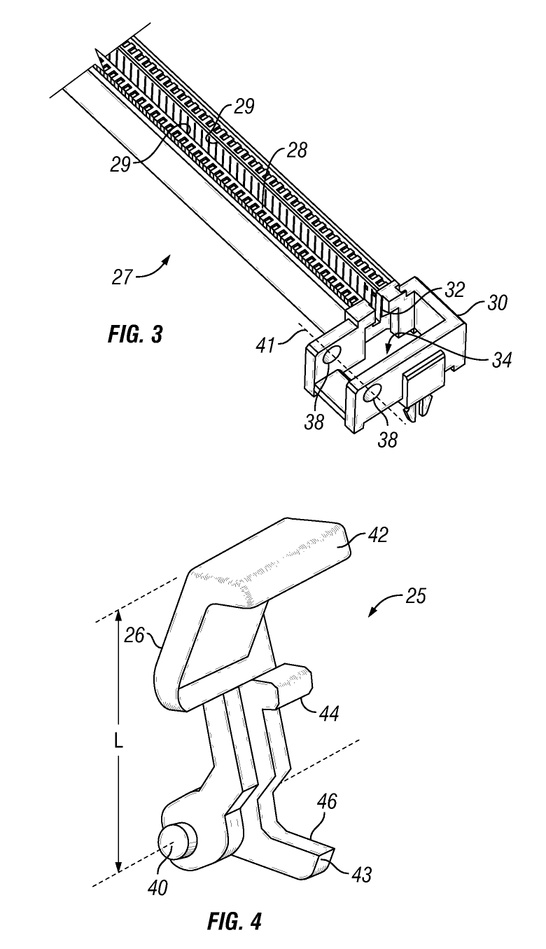

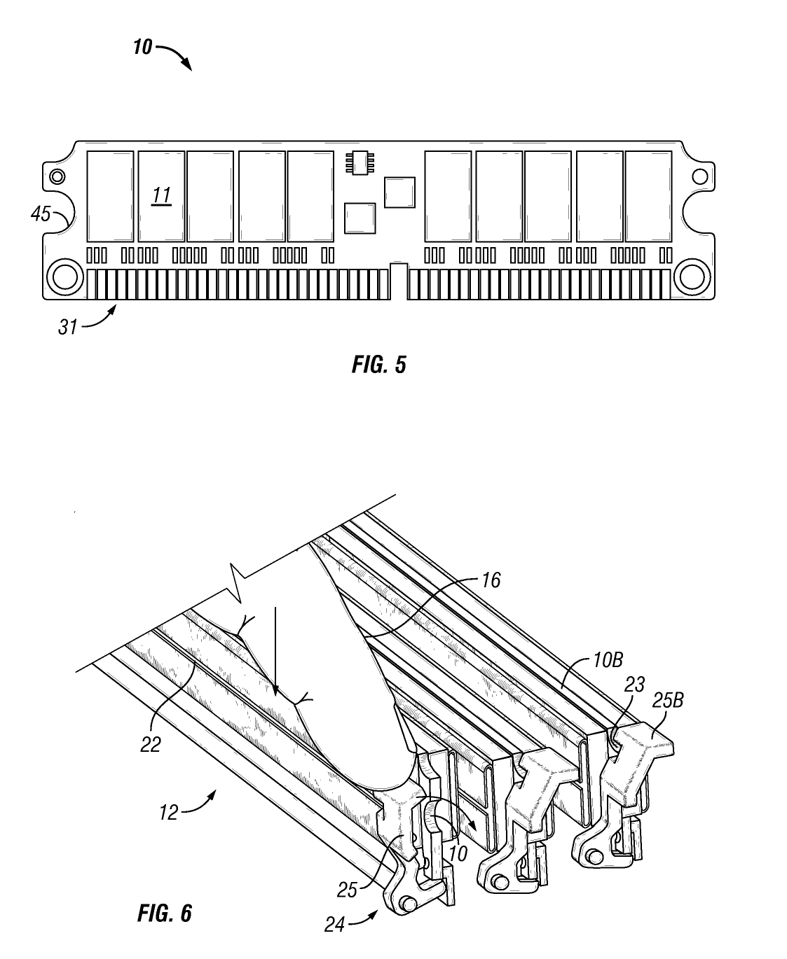

FIGS. 3 and 4 provide further details of components of the latch 24. FIG. 3 is a perspective view of the connector body 27, and FIG. 4 is a perspective view of the lever 25, enlarged to show detail. FIG. 5 is a view of the VLP DIMM 10 taken in a plane that is generally parallel to the longitudinal face 11 of the VLP DIMM 10. In discussing the cooperative relationships between the connector body 27 and the lever 25, and between the VLP DIMM 10 and the connector 12, alternating reference may be made to FIGS. 3, 4, and 5.

The connector body 27 includes a DIMM socket or “slot” 28 for receiving the VLP DIMM 10. The slot 28 is empty (the VLP DIMM 10 is not inserted). The slot 28 has a set of terminals (“socket terminals”) 29 for electrical engagement with a corresponding set of terminals (“DIMM terminals”) 31 on the VLP DIMM 10. The socket terminals 29 may provide electronic communication pathways between the VLP DIMM 10 and a memory controller on a motherboard. The socket terminals 29 are typically I/O (input/output) type terminals, for carrying I/O signals such as data, strobe, and address between the memory controller and the VLP DIMM 10.

The lever support structure 30 is disposed adjacent to an end 32 of the slot 28 at a corresponding end of the connector body 27. Although not required, the connector body 27 in this embodiment is unitarily formed with the lever support structure 30 structure. In other embodiments, the lever support structure 30 may be structurally separate from the connector body 27, such as mounted directly to a motherboard adjacent to and in alignment with the connector body 27. The lever support structure 30 includes an opening or pocket 34 for receiving a lower end 36 of the lever 25. A pair of aligned pivot support holes 38 receives a corresponding pair of aligned male pivot members 40 on the lever 25. In this embodiment, the male pivot members 40 are circular bosses or protrusions 40 that fit within the respective holes 38, forming a hinged connection. Alternative mechanisms for pivotally mounting one member to another are known in the art, and may be substituted herein for the holes 38 and protrusions 40. Whatever the mechanism employed for pivotally securing the lever 25, the pivot axis 41 will be oriented generally parallel to a longitudinal plane of the DIMM, which is aligned with the slot 28. This orientation of the pivot axis 41 is ninety-degrees apart from that of the pivot axis of the conventional lever 15 of FIG. 1. Advantageously, this orientation of the pivot axis 41 does not require the additional lateral clearance required by the conventional lever 15. The lever 25 does not move outward like the lever 15, so movement of the lever 25 does not increase the effective length of the connector 22.

The lever 25 includes a push point or “grip portion” 42 for the user's finger to push or pull on to pivot the lever 25 about the pivot axis 41. The grip portion 42 may be textured to provide a more secure “grip” with the user's finger. The lever 25 includes an upper engagement portion 44 for applying a downward force to the VLP DIMM 10 at a location 45 to urge the VLP DIMM 10 at least partially downward, i.e. into the slot 28, when the lever 25 is moved clockwise about the axis 41. With the DIMM fully inserted into the slot 28, the upper engagement portion 44 may also retain the DIMM within the slot 28. The lever 25 also includes a lower engagement portion or “leg” 46 for applying a generally upward force to the VLP DIMM 10 at a location 47, to urge the VLP DIMM 10 at least partially upward, i.e. out of the slot 28, when the lever 25 is moved counter-clockwise about the axis 41 relative to the orientation of FIG. 3.

The lever 25 provides increased mechanical advantage as compared with the conventional lever 15 (FIG. 1). In particular, the lever 25 provides a longer “lever arm” than the conventional lever 15. The lever arm is the distance, roughly dimensioned in the figure as “L,” from the pivot axis 41 to the line of action of the force applied by the finger to the grip portion 42. In the conventional lever 15, the lever arm may be less than the lever arm of the lever 25 in this embodiment. Because the lever 25 is not pivoted laterally outward, the lever 25 may be made longer without adversely affecting lateral clearance. Moreover, because the lever 25 is positioned adjacent the end 32 of the slot 28, the lever 25 may also be made longer without impinging other connectors arranged in close proximity to the connector body 27.

The pivot axis 41 of the lever is laterally spaced from the centerline of the VLP DIMM 10, as discussed previously. This spacing increases the reach of the leg 46 with respect to the pivot axis 41, to increase the vertical displacement of an end 43 of the leg 46 for a given angular displacement of the lever 25 about the pivot axis 41. Thus, the VLP DIMM 10 may be released from the connector 22 with less angular movement of the lever 25.

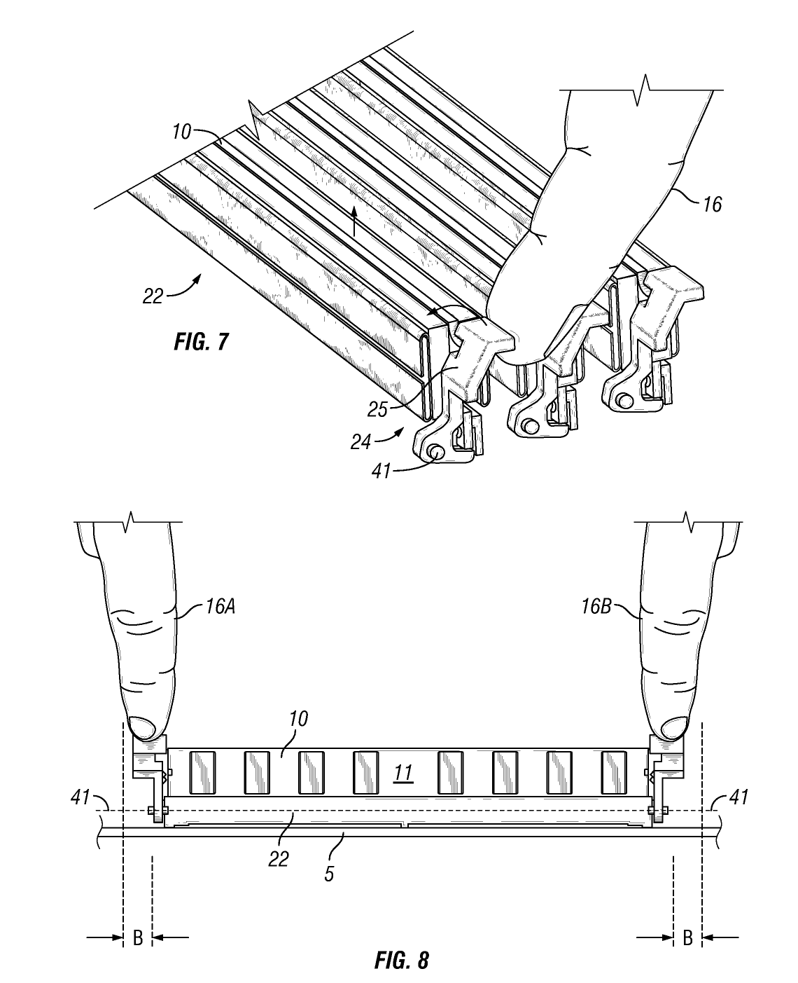

FIG. 6 is a perspective view of the DIMM connectors 22, with one of the latches 24 being operated to insert and secure the VLP DIMM 10 in a corresponding one of the connectors 22. The VLP DIMM 10 is in a “raised” position, which may be at the onset of insertion. The lever 25 is shown in an “open” position. The lever 25 is being operated by the user's finger 16 to urge the VLP DIMM 10 into the connector 22. As indicated by an arrow, the user's finger 16 moves the lever 25 clockwise, causing the upper engagement member 44 (see FIG. 4) to apply a generally downward force to the VLP DIMM 10. This downward force may be at the single notch 45 on the side of the VLP DIMM 10 (see FIG. 5). Alternatively, the connector 22 may interchangeably accommodate a full-height DIMM (not shown) having two notches on the side. In the case of receiving a full-height DIMM, the engagement member 44 may engage a first, lower notch while the second, upper notch receives the grip portion 42 as the lever 25 is moved in the direction indicated in FIG. 6. Completion of this movement urges the VLP DIMM 10 into a fully seated position within the connector 22, as shown in FIG. 7. The increased mechanical advantage of the longer lever 25 makes it easier for the user to insert and secure the VLP DIMM 10 within the connector 22.

The lever 25 is also shaped to avoid interference with the VLP DIMM 10. One of the levers 25B in FIG. 6 is shown in a closed position. In this closed position, a relief portion 23 provides the necessary relief for the lever 25B to move to this closed position without interference with the edge of the VLP DIMM 10B.

FIG. 7 is a perspective view of the DIMM connectors 22, with the latch 24 being operated to release and raise the VLP DIMM 10 from its fully seated, “lowered” position. The position of FIG. 7 may have resulted, for example, from completion of the clockwise movement of the lever 25 caused by the user's finger 16 to seat the VLP DIMM 10 in FIG. 6. The lever 25 is shown in a “closed” position. The lever 25 is being operated by the user's finger 16 to release and raise the VLP DIMM 10 from the connector 22. As indicated by an arrow, the user's finger 16 moves the lever 25 counter-clockwise, causing the lower engagement member 46 (FIG. 4) to apply a generally upward force to the VLP DIMM 10, such as at location 47 of FIG. 5. This movement will release and forcibly raise the VLP DIMM 10. The increased mechanical advantage of the longer lever 25 makes it easier for the user to release and raise the VLP DIMM 10 from the connector 22. The spacing of the pivot axis allows the VLP DIMM 10 to be raised with minimal angular rotation of the lever 25.

FIG. 8 is a front view of the connector 22 and the inserted VLP DIMM 10, illustrating the reduced length and footprint of the connector 22. As shown, the user's fingers 16A, 16B move the levers 25 about the pivot axis 41, which is oriented parallel to the longitudinal face 11 of the VLP DIMM 10. Thus, the levers 25 do not move laterally outward like the levers 15 of the conventional connector 12 in FIG. 1. As shown, the required clearance “B” need only take into account the width of the user's fingers 16A, 16B. No extra clearance is required about the connectors 22 to accommodate the movement of the levers 25 about the pivot axis 41. Thus, clearance B is noticeably less than the clearance A.

A study has demonstrated that the embodiment of the connector 22 results in a 14% reduction in the length of the connector footprint, and a circuit board space savings of 20 mm (7.5%) of the motherboard area. This length and space savings is quite significant, particularly in view of the desire to provide high density component boards and to maximize efficient use of space on a computer's motherboard, as well as the volume of the computer's chassis.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A memory module connector, comprising:
a connector body having a slot for removably receiving a DIMM; and
at least one latching mechanism including a lever pivotally secured adjacent to an end of the connector body on a pivot axis oriented generally parallel to a longitudinal face of the DIMM, the lever being movable about the pivot axis from a first position for securing the DIMM in the slot and a second position for releasing the DIMM from the slot, wherein the lever does not extend outside a projected width of the connector body when moving between the first and second positions.

2. The memory module connector of claim 1, wherein the pivot axis is laterally spaced from the DIMM.

3. (canceled)

4. The memory module connector of claim 1, wherein the lever comprises an upper engagement member for engaging a portion of the DIMM to move the DIMM at least partially into the slot during movement of the lever from the second position to the first position.

5. The memory module connector of claim 1, wherein the lever comprises a lower engagement member for engaging another portion of the DIMM to move the DIMM at least partially out of the slot during movement of the lever from the first position to the second

6. The memory module connector of claim 1, wherein the connector body is configured for receiving a VLP-type DIMM.

7. The memory module connector of claim 1, wherein the connector body is configured for receiving a full-height DIMM.

8. The memory module connector of claim 7, wherein the lever further comprises:
a push point configured to be received in an upper notch of the full-height DIMM when the lever is in the first position; and
a lower engagement member configured to engage a lower notch of the full-height DIMM when the lever is being moved from the second position to the first position.

9. The memory module connector of claim 1, wherein the connector body is configured for receiving either a VLP-type DIMM or a full-height DIMM, and wherein the lever further comprises a push point configured to be received in an upper notch of the full-height DIMM when the lever is in the first position and a lower engagement member is configured to engage a lower notch of the full-height DIMM when the lever is being moved from the second position to the first position.

10. A memory module assembly, comprising:
a plurality of connectors having connector bodies oriented parallel to one another on a motherboard, each connector body having a slot for removably receiving a respective DIMM; and
at least one latching mechanism included with connector, each latching mechanism including a lever pivotally secured adjacent an end of the respective connector body on a pivot axis oriented generally parallel to a longitudinal face of the respective DIMM, the lever being movable about the pivot axis from a first position for securing the respective DIMM in the slot and a second position for releasing the respective DIMM from the slot, wherein the lever does not extend outside a projected width of the connector when moving between the first and second positions, and wherein the pivot axis is laterally spaced.

11. The memory module assembly of claim 10, wherein the pivot axis is laterally spaced from the face of the DIMM.

12. (canceled)

13. The memory module assembly of claim 10, wherein the lever of each latching mechanism comprises an upper engagement member for engaging a portion of the DIMM to move the respective DIMM at least partially into the slot during movement of the lever from the second position to the first position.

14. The memory module assembly of claim 10, wherein the lever of each latching mechanism comprises a lower engagement member for engaging another portion of the DIMM to move the DIMM at least partially out of the slot during movement of the lever from the first position to the second position.

15. The memory module assembly of claim 10, wherein one or more of the connector bodies are configured for receiving a VLP-type DIMM.

16. The memory module assembly of claim 10, wherein one or more of the connector bodies are configured for receiving a full-height DIMM.

17. The memory module assembly of claim 16, wherein the lever further comprises:
a push point configured to be received in an upper notch of the full-height DIMM when the lever is in the first position; and
a lower engagement member configured to engage a lower notch of the full-height DIMM when the lever is being moved from the second position to the first position.

18. The memory module assembly of claim 10, wherein each of the connector bodies are configured for receiving either a VLP-type DIMM or a full-height DIMM, wherein the lever further comprises a push point configured to be received in an upper notch of the full-height DIMM when the lever is in the first position and a lower engagement member configured to engage a lower notch of the full-height DIMM when the lever is being moved from the second position to the first position.

19. The memory module of claim 10, wherein the pivot axis is laterally spaced from the DIMM.
